(19) United States
(12) Patent Application Publication
(10) Pub. No.: US 2008/0158078 A1
(43) Pub. Date: Jul. 3, 2008

(54) Satellite Dish System and Method

(75) Inventors: Jason Allen, Red Deer (CA); Orrin Thomas Lind, Springbrook (CA); Benny Borgman, Red Deer (CA); Darrell Graeme Booth, Calgary (CA)

Correspondence Address: LOCKE LORD BISSELL & LIDDELL LLP;ATTN: IP DOCKETING, 600 TRAVIS, SUITE 3400, HOUSTON, TX, 77002-3095, US

(73) Assignee: MOBILESAT COMMUNICATIONS INC., Red Deer (CA)

(21) Appl. No.: 11/761,136

(22) Filed: Jun. 11, 2007

Related U.S. Application Data
(60) Provisional application No. 60/812,100, filed on Jun. 9, 2006.

(51) Int. Cl. H01Q 3/00; G01S 5/00

(52) U.S. Cl. 343/757; 342/357.15

(57) ABSTRACT

There is provided a satellite dish system for comprising a satellite dish mount providing an operable position and a stored position, a controller for effecting position changes for the satellite dish mount and a modem connected to the controller for coupling a computer to a data network via a communications satellite. There is also provided a method of aligning a satellite dish comprising the steps of determining satellite elevation in dependence upon geographic position, rotating the satellite dish at the determined elevation to locate a desired satellite, detecting a signal from the desired satellite and incrementally adjusting rotation and elevation of the satellite dish in dependence upon signal strength.

This non-provisional application claims benefit to U.S. Provisional Application No. 60/812,100.

### FIELD OF THE INVENTION

The present invention relates to satellite dish systems, and more particularly to alignment of satellite dishes.

### BACKGROUND OF THE INVENTION

It is well known that satellite systems are employed in the provision of Internet and related services. In particular industries, such as the petroleum industry, which often operate in remote locations and do not have ready access to cable-based Internet systems, the option of using satellite technology is an attractive one.

Previously, only Ku-band satellite service was available worldwide for two-way Internet communication. The providers of such services include DirecWay, Tachyon, Comstream, I-Direct, and ViaSat. One of the prohibiting factors of using a Ku-band satellite system, however, is that the farther north a user travels the larger the satellite dish that is required. For example, south of the 40th parallel one can use a 0.74 meter dish, from the 40th to the 60th parallel a 1.2 meter dish is required, and above the 60th parallel a 2.4 meter (or larger) dish is required. A larger dish entails greater expense in both equipment and service, and if the users location must regularly shift over significant distances, such as is the case with some mobile oil rigs, a number of different sized dishes will be required.

There are several “auto-tuning” or self-aligning mounting systems (also referred to as “auto aimers”) for Ku-band satellite services. These mounting systems are designed for use with DirecWay, I-Direct, Comstream, and ViaSat Ku-band platforms. These platforms are traditional satellite Internet services that use one beam for all of North America, with an identifier signal within the transmitting frequency. This allows the auto-tuning satellite dish mounting system to lock onto the correct satellite and tune in to the satellite for the Ku-band modem to communicate with the satellite. However, no current single self-aligning mounting system can be used throughout all of North America with a Ku-band system.

The most consistent complaint of such satellite service customers is that the 1.2 meter systems (which are required for connectivity in Canada) are undesirable, and that the price is too high for the service they are receiving. It is difficult for customers to accept that they can pay approximately $50 per month for residential high-speed Internet, but need to pay $3000 to $9000 per month for the same type of service at a remote location. It is understood that it should reasonably cost more, given the remote and temporary setting, but the problem remains. Most remote users simply want to be able to use electronic mail, access the World Wide Web, send in reports from the field and perhaps use VoIP services, which are all services available at much lower cost in established service areas.

Ka-band satellite Internet has only been available since the Summer of 2005. Telesat launched the Anik F2 satellite, which was the first Ka-band Internet satellite, in the Spring of 2005, although this was experimental as the satellite industry was not sure that such spot beam technology would work, Ka-band satellite dishes are currently sold for residential and small office use, and there are currently no Ka-band auto aimers. Ka-band Internet service uses 45 spot beams to cover North America, and does not incorporate an identifier frequency within the signal to lock on to. The Telesat service is offered by WildBlue in the United States and several distributors in Canada.

The new Ka-band service offers high-speed Internet with a single dish size (67 cm) at what is generally understood to be a reasonable cost. The Ka-band services are generally offered at from $50 per month to $200 per month, depending on the level of service that is required. The cost of the equipment required to be able to receive this service ranges from $400 to $800, which equipment is meant to be established at a fixed location, such as the roof of a building. There is currently no mobile mount that will point a Ka-band dish at the appropriate satellite, and an installation technician would be required.

Despite the clear advantages in utilizing Ka-band technology, the Telesat service is designed for stationary locations, such as residential and commercial buildings. This fails to address the needs of industries and individuals located or working in remote locations.

A self-aligning mount is crucial where the access location is moved on a regular basis. Oil rigs, for example, change locations so often that they currently require a satellite technician to follow the rig and move the satellite dish every time the rig moves. As is clear, this is extremely costly. The rig managers and consultants on the rig sites are normally not satellite technicians and are not trained to set up a satellite dish. To manually set up either a Ka-band or a Ku-band dish certain tools are required, and a certified technician is also required to prevent damage to the satellite or the satellite dish.

An automated mount generally points the dish more accurately than a person can, as it has a finer accuracy level. By using an automated mounting/pointing system, the need for a technician to follow the rigs around and move the satellite dishes with the rig is eliminated. This automation, if combined with the new, less expensive Ka-band service, would allow the price to dramatically drop to a range which most prospective users can afford.

The problem remains, however. Although Ka-band service is clearly preferable to the standard Ku-band service, the lack of a means to enable self-aligning mobile dish systems renders the Ka-band service undesirable for users in remote, shifting locations.

What is needed, therefore, is a method and system for a self-aligning satellite dish system that can be used with Ka-band service.

### SUMMARY OF THE INVENTION

An object of the present invention is to provide an improved satellite dish system.

In accordance with an aspect of the present invention there is provided a satellite dish system for comprising a satellite dish mount providing an operable position and a stored position, a controller for effecting position changes for the satellite dish mount and a modem connected to the controller for coupling a computer to a data network via a communications satellite.

In accordance with another aspect of the present invention there is provided a method of aligning a satellite dish comprising the steps of determining satellite elevation in dependence upon geographic position, rotating the satellite dish at the determined elevation to locate a desired satellite, detecting a signal from the desired satellite and incrementally adjusting rotation and elevation of the satellite dish in dependence upon signal strength.

### BRIEF DESCRIPTION OF THE DRAWINGS

The present invention will be further understood from the following detailed description with reference to the drawings in which:

FIG. 1 illustrates in a perspective drawing, a satellite dish system in accordance with an embodiment of the present invention;

FIG. 2 illustrates satellite dish system of FIG. 1 moving to its stored position; and

FIG. 3 illustrates in an exemplary satellite dish system;

FIG. 4 illustrates an exemplary controller;

FIG. 5 illustrates exemplary controller schematic circuit diagram;

FIG. 6 illustrates exemplary controller block circuit diagram; and

FIG. 7 illustrates ANIK F2 Ka band edge coverage patterns.

### DETAILED DESCRIPTION OF THE PREFERRED EMBODIMENT

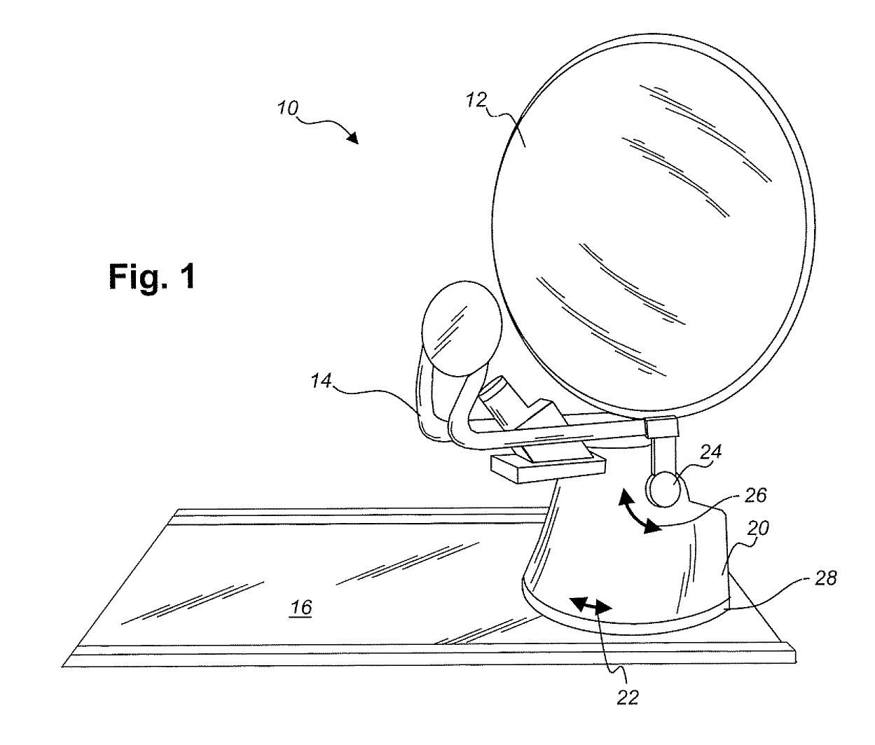

Referring to FIG. 1 there is illustrated, in a perspective drawing, a satellite dish system in accordance with an embodiment of the present invention. The satellite dish system 10 includes a dish 12 and receiver assembly 14 all mounted on a base 16 via a rotating turret 20. The turret 20 provides for rotational movement, as indicated by arrow 22, of 380 degrees. The dish 12 also pivots on mount 24 from 0 to 90 degrees elevations, as indicated by arrow 26. The rotational movement 22 is facilitated by a Teflon™ skid plate 28.

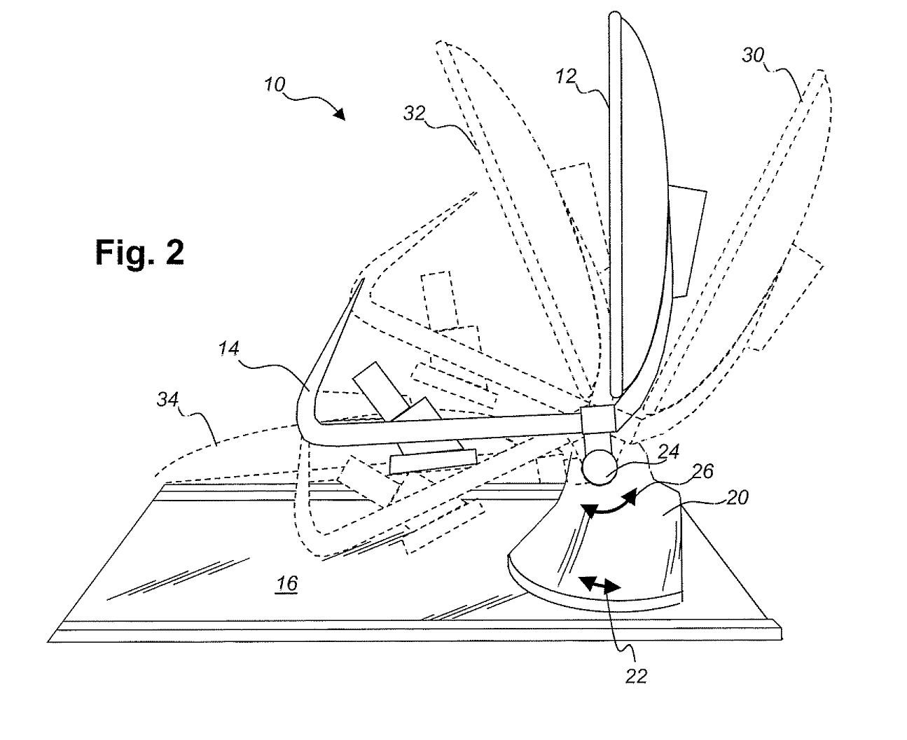

FIG. 2 illustrates satellite dish system of FIG. 1 moving to its stored position. In FIG. 2, the satellite dish assembly has been rotated to a pre-storage position 30, which is aligned with the base 16. As the dish assembly collapses to its stored position, the receiver assembly 14 touches the base 16 at position 32, then the dish 12 continues to fold to position 34, covering the receiver assembly 14.

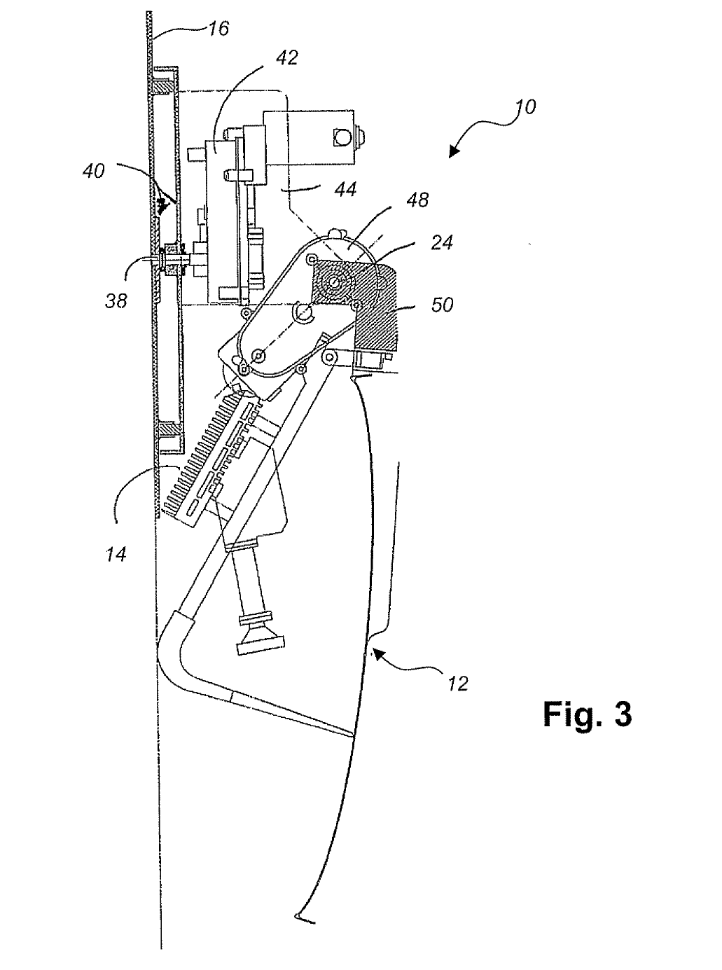

Referring now in detail to FIG. 3, there is illustrated an exemplary satellite dish system 10, for mounting a satellite dish 12. As the satellite dish system 10 is intended to be externally mounted and subject to regular transport, the satellite dish system 10 is designed to be collapsible and stow generally flat, such that no portion is more than 12 inches above the surface to which it is mounted. When the unit is not being transported and it is desired that communication be established with the satellite, the dish 12 must raise vertically and rotate on its axis to sweep the sky and locate the appropriate satellite, lock onto that satellite and maximize and maintain the available signal strength.

The satellite dish system has a base 16 formed from 3/16 inch aluminum sheet. It is generally rectangular in shape, approximately 24 inches wide and 48 inches long with a longitudinal break near each edge for rigidity. The base 16 has four stainless steel handles (not shown in the figures), one near each corner, to facilitate lifting and positioning. The base 16 and handles also make the unit 10 adaptable to various mounting requirements: it may be set on the ground, fastened into the box of a pickup truck, mounted to the roof of a trailer or shack, and so on.

A ¾ inch×5 inch steel shaft 18 is mounted vertically along the longitudinal centerline of the base 16, 12 inches from one end. The shaft has a ⅛ inch wide× 1/16 inch deep keyway groove along its length. A ¾ inch thick×3 inch OD×¾ inch ID washer of UHMW plastic is placed over the center of the shaft 18 as an inner bearing, and this inner bearing is free to rotate about the shaft 18. An outer bearing is fastened to the base 16. This outer bearing is composed of two semicircular pieces of ¾ inch thick×1½ inch wide UHMW plastic, forming an outer diameter of 15½ inches. The outer bearing has a 1 inch wide gap in the circumference to allow for passage of wires (not shown). The required wires would be laid into position prior to the next step.

A 15½ inch diameter plate 20 of 3/16 inch aluminum with a ¾ inch hole in the center is placed over the shaft 38 and rests on the inner and outer plastic bearings, the edge of the aluminum plate 40 in close alignment with the outside edge of the plastic bearing. The circular aluminum plate 40 is free to rotate about the shaft 38. The wires would come through the plate 40 near its center.

A first 12 volt DC gear motor 42 is then mounted onto the shaft 38. The first gear motor 42 has a gear reduction ratio in the order of 4000/1, thereby allowing for a rotation speed of about ½ rpm. The motor 42 has a rotation counter to allow for electronic monitoring of revolutions. The final gear of the gear motor 42 assembly has a ¾ inch hole through it with a ⅛ inch wide× 1/16 inch deep keyway groove. The gear motor assembly 42 is dropped over the vertical shaft 38 and mated with that shaft 38 by use of a ⅛ inch×⅛ inch×¾ inch key in the adjoining keyway slots of the shaft 38 and the gear motor 42. The gear motor 42 is fastened to the 15½ inch diameter plate 40, and since the plate 40 is free to rotate around the shaft 38, activation of the gear motor 42 causes the plate 40 to rotate around the vertical shaft 38. The gear motor 42 and circular plate 40 are held down to glide on the plastic bearings by use of a nut and washer. Above the nut at the top of the shaft 38 is a collar with a thin metal tab fastened to its circumference. The tab is used to trip limit switches that restrict the rotation of the circular plate 40 to 380 degrees of arc. It is important that the amount of rotation be limited because of the wires routed through the gap in the outer plastic bearing and up through the plate 40, which wires are used to control motor function and connect with the BUC (block up converter) 14 to allow for data transfer. In order to allow for rotation, the wires are wrapped in a loop around the center axis and trapped in the space formed by the inner and outer plastic bearings between the base 16 and the circular plate 40. Too much rotation in either direction would cause the wires to bind and possibly damage the wires or stall the mechanism. On the other hand, the unit must be able to rotate more than 360 degrees in the event that the appropriate satellite happens to be right at the 360/0 point, in which case it might otherwise be difficult to detect and optimize the signal. The design of the collar with tab and the design and positioning of the limit switches allows for an additional 20 degrees of arc beyond a simple 360 degrees in order to allow for this possibility. This is achieved by two on/off switches placed in a V on the collar located on the gear motor 42, allowing the additional 20 degree off-set. When the tab located at the top of the shaft 38 rotates, it hits the on/off switch. The tab is welded to the main shaft 38 which comes up through the azimuth motor gearbox, and as the azimuth motor turns to the right the tab hits the limit switch on the right, stopping the motor, then the motor turns to the left 380 degrees before it hits the other on/off switch.

The satellite dish system 10 provides for horizontal rotation that allows the unit to sweep the horizon left and right as it searches for the correct satellite.

Following is a description of the mechanism designed to raise and lower the dish assembly 12 to sweep the sky in a vertical (up and down) motion and also to stow it flat for transport or long term storage.

The geometry of the satellite dish 12 and BUC assembly 14 are such that if one is limited to a maximum height of 12 inches above the surface to which the base 16 is mounted, then the pivot point of the assembly should be about 8 inches above the base 16. The motor and axle are mounted and supported at that point, so a support structure is required. For this purpose, the exemplary embodiment employs a piece of rectangular aluminum tubing (4 inches×6 inches×¼ inch wall thickness×10½ inches high), referred to by the numeral 44. The tubing 44 is itself centered over the center point of the circular plate 40; as such, it straddles part of the gear motor 42 attached to the circular plate 40, and a section of the lower sidewall of the tubing 44 is cut away to accommodate this. The rectangular tubing 44 is then fastened to the circular plate 40.

The pivot axle 24 is a piece of ¾ inch diameter shaft×9 inches long with a ⅛ inch× 1/16 inch keyway running the full length of the shaft 24. The pivot point is established at the required height along the vertical centerline of the 6-inch side of the tubing 24 and a ⅞ inch diameter hole is drilled through the two sides of the tube 24. A second gear motor 48 (of similar design to the first gear motor 42) is attached to the 6-inch side of the tubing 44. The rectangular tube 44 has some sections removed to allow for mounting of the motor 48 and excess material near the top will be removed to create a rounded top. The gear motor 48 is mounted such that the center of the final gear is aligned with the center of the ⅞ inch drilled hole. The ¾ inch×9 inches pivot axle 24 passed through the hole in the final gear of the mounted gear motor 48 and is mated with a ⅛ inch×⅛ inch×¾ inch key such that as the gear rotates, so will the pivot axle 24.

Two pivot arms 50 of ¼ inch aluminum plate are used to transfer rotation from the pivot axle 24 to the dish 12 and BUC assembly 14. The pivot arms 50 have a ¾ inch hole near one end. A collar with a keyway is centered over the hole in one of the arms 50 and is fastened to the inside edge of the arm 50. The pivot axle 24 pass through this collar and is mated with a ⅛ inch×⅛ inch×¾ inch key so that as the pivot axle 24 rotates, so does the arm 50. The arms 50 are designed to fit inside the 4 inch dimension of the tube 44, allowing for a washer to separate the edge of the arm 50 from the inside edge of the tubing 44. The two arms 50 are held apart at the proper distance on the shaft 24 by a 1 1/16 inch OD×¾ inch ID×2¼ inch long spacer sleeve that takes up the room between the inner collar on one arm 50 and the inside edge of the other arm 50. The ¾ inch pivot axle 24 passes through this sleeve. A torsion spring is placed over the sleeve with one leg attached to the inside edge of one of the pivot arms 50 and the other leg supported by an adjustment screw mounted to the 4 inch side of the tubing 44. The spring will hold tension on the assembly as it rises in order to minimize the effects of strong winds and/or gear slop within the gearbox. The adjustment screw will allow for adjusting spring tension to the desired force. This also allows for adjustments related to the fact that the required angle of inclination changes depending on global latitude position.

This portion of the unit would be assembled as follows: The ¾ inch diameter pivot axle 26 would be passed through the center of the final gear of the gear motor 48 and through the ⅞ inch hole in the wall of the tubing 44. A washer would be placed over the shaft 24 as it comes through the inside wall of the tubing 44 and then the shaft 24 would pass through the pivot arm 30 that has the collar with keyway—a key would be inserted at this point—and the shaft 24 then passes through the spacer sleeve (with the spring already positioned on the sleeve), through the second pivot arm 50, through another washer, through the wall of the tubing 44 and then into a bearing mounted on the outside wall of the tubing 44 at that point. A locking collar is attached to the end of the pivot axle 24 at the outside edge of the bearing to keep the axle 24 in place. This locking collar also has a thin metal tab attached to its circumference in order to actuate limit switches for up and down movement. The limit switches are attached to the 6 inch side of the rectangular tube 44. A key would now be inserted at the other end of the axle 24 to mate with the final gear of the gear motor 38 and a collar with setscrew would be added at that end to keep the key and axle 24 in position.

When the gear motor 48 is activated, the pivot shaft 24 will rotate, supported by the gear box at one end and by the bearing at the other end. The pivot arms 50 will be joined together by the dish support and since one arm 50 is keyed to the pivot axle 24, as the pivot axle 24 moves so will the dish support. Also, as the pivot arm 50 moves up, it will contact and then build tension in the torsion spring, the amount of tension being adjustable as required. Up and down travel of the assembly will be halted by limit switches to prevent excessive travel and possible damage to the mechanism.

Wiring for the limit switches and gear motor controls could now be connected.

A protective cover 20 of FIGS. 1 and 2, is placed over the circular base 40 and mounted components, leaving only wires for the BUC (Tria) 14 and the two pivot arms 50 extending through the cover. The pivot arms 50 raise and lower through two slots in the cover, and the wires pass through a drilled hole. The protective cover 20 is fastened to the circular base 40 and shields the gear motors 42, 48 and other components from the elements. Some moisture and dust will get past the cover and, accordingly, components under the cover are sealed or shielded as necessary and corrosion resistant materials are used whenever possible.

The dish support is attached to the two pivot arms 50, joining them together in a “U” shape, and the satellite dish 12 is attached to the dish support.

The BUC assembly (Tria) 14 is also attached to the dish support. The assembly includes two pieces of ¾ inch square aluminum bar, hinged to the dish support near the base of the dish 12. A reflector disc is mounted at the opposite end of the bars and this disc relays the data signals to and from the BUC (Tria) 14 and dish 12. The BUC (Tria) 14 is mounted in the middle of the arms 50 between the satellite dish 12 and the reflector disc. The hinged arms 50 allow the dish 12 to lay down against the disc and BUC (Tria) assembly 14 or to be oriented at approximately 90 degrees to the arms/disc/BUC (Tria) when in the raised position. A torsion spring at the hinge point helps keep the arms/disc/BUC (tria) assembly properly positioned. The dish 12 is laid down with the back or convex surface of the dish 12 facing upwards to help shed rain and snow. This also helps keep rain and snow off the arms/disc/BUC assembly since they are underneath the dish 12 in the stowed flat position.

The geometry of the relative positions of the dish 12, disc and BUC (tria) 14 is critical, therefore requiring precise placement of hinge locations and mounting points. The design allows for adjustments to the geometry as necessary to maximize signal quality.

This assembly then allows for automated electronic control of the unit. Control wiring is routed and protected as necessary. The satellite dish system can lift a heavy snow load when rising from the stowed position and operate in ambient conditions from −40C to +50C and above. It is designed to minimize interference from wind, rain, ice and snow such that it can be expected to perform well in most weather conditions.

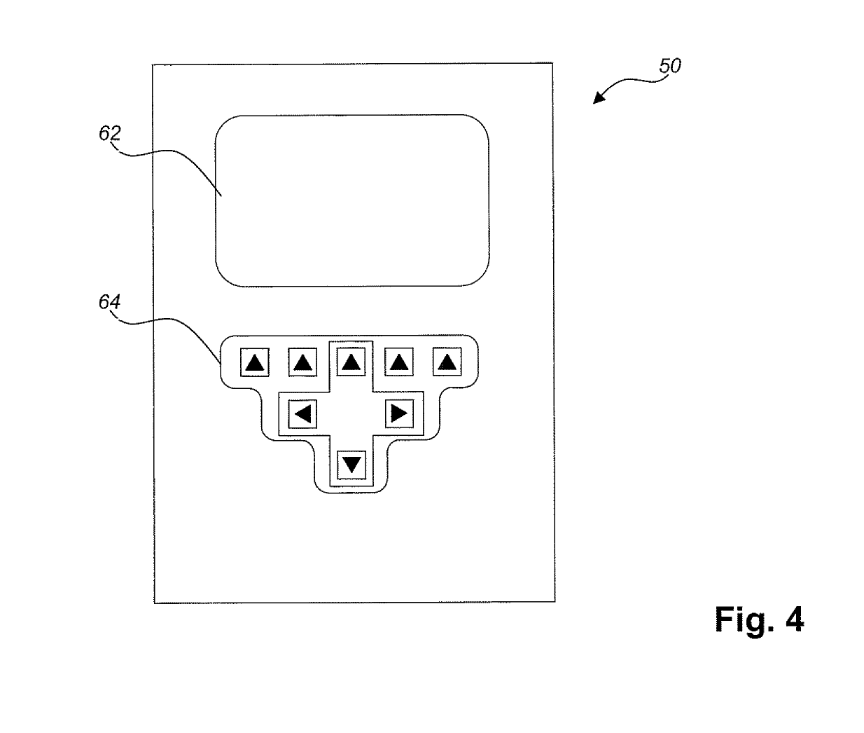

Referring to FIG. 4 is illustrated an exemplary controller. The controller 60 includes a touch screen 62 and keypad 64.

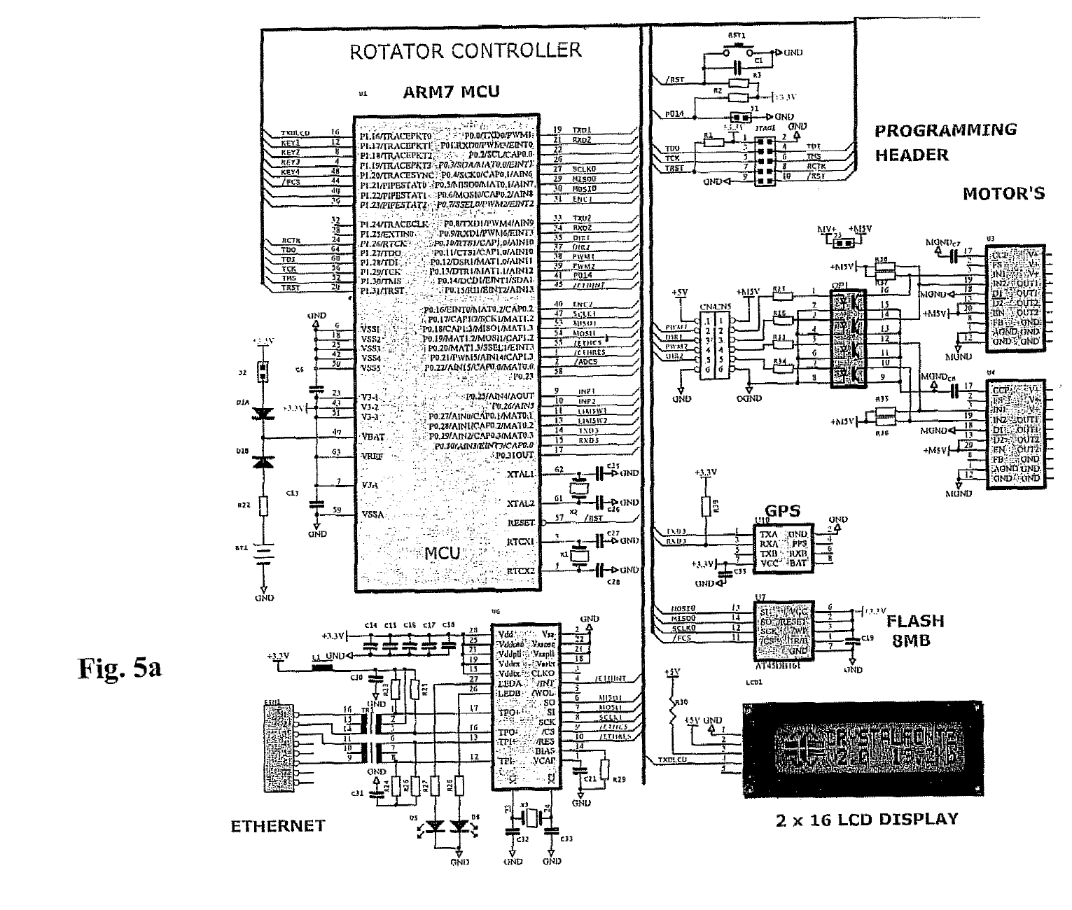

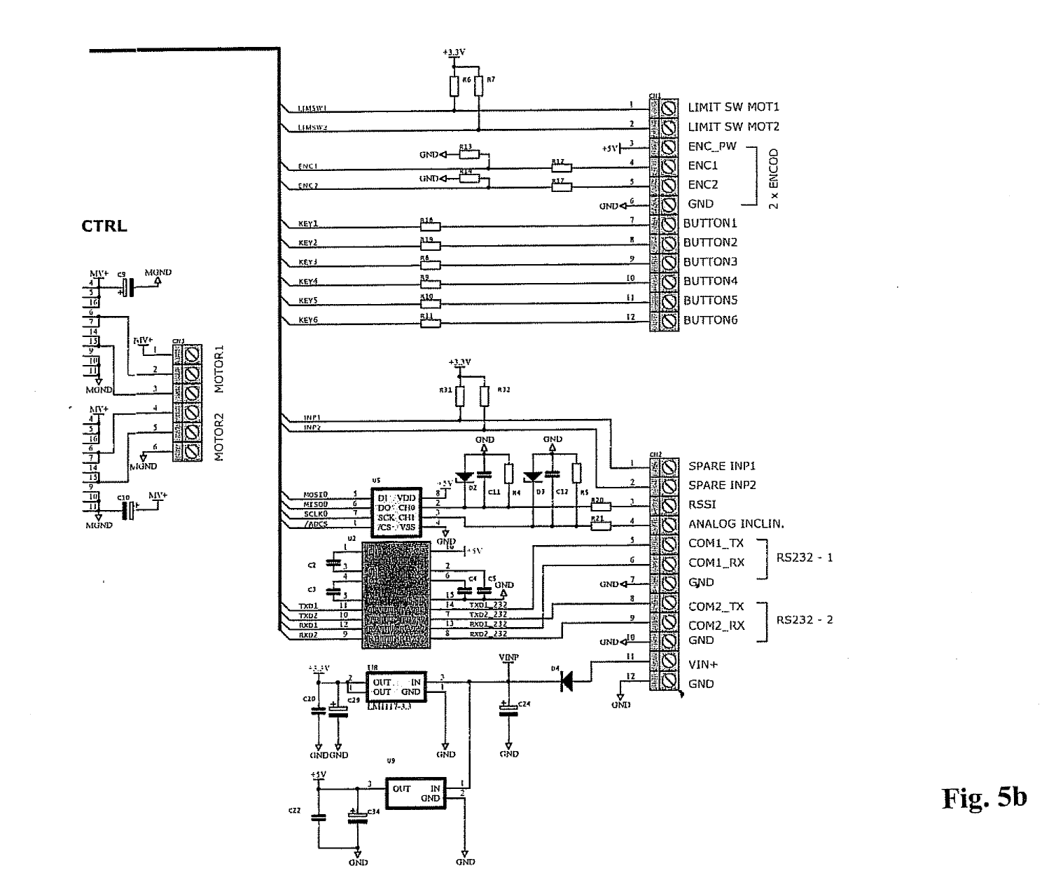

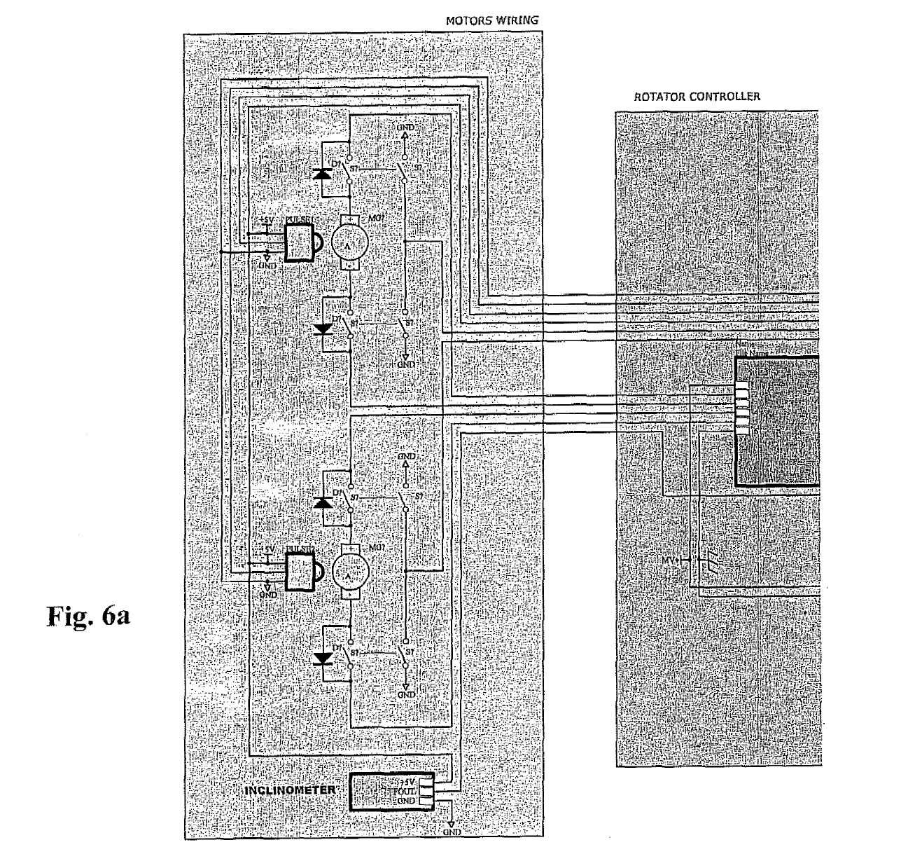

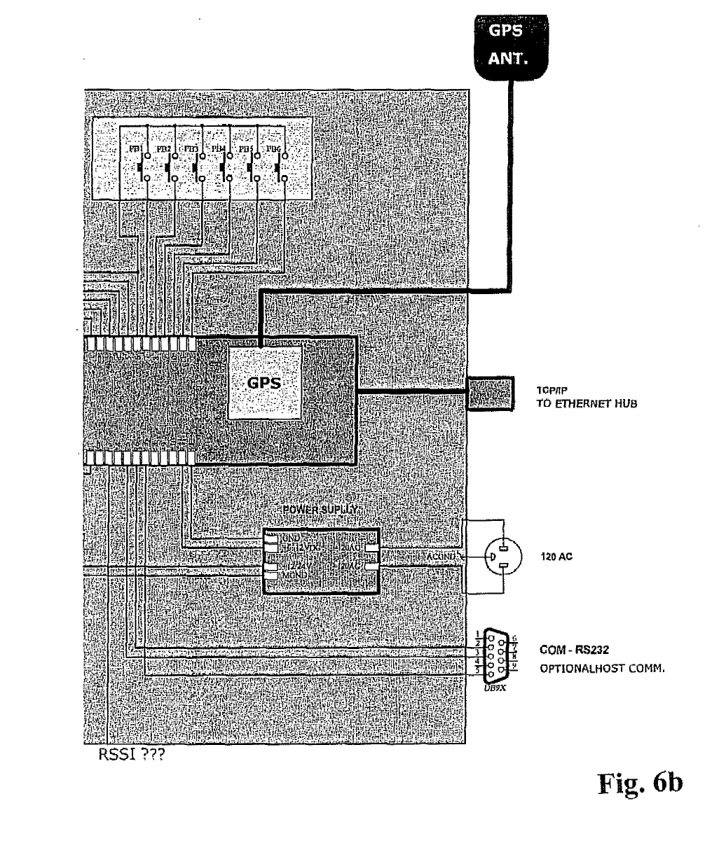

Referring to FIGS. 5 and 6 there are illustrated exemplary controller circuit diagrams.

Controller design notes are set out below:

### PENIO06 MOD Version of Controller Design Notes

1. Refer to wiring and schematics diagrams for correct connection of external inputs outputs.
2. Connect 12 pin (Brown) Molex socket connector to CN2 of main board. PIN 1 of CN2 should be oriented to GND) (Brown) Pin 2 to VIN+ (Yellow)
3. Connect temporary prototype keypad (6 Keys) to pin 6-12 of CN1. (See drawing for socket orientation)
4. Plug in 3 pin socket of Inclinometer to PIN 1,2,3 of CN1. PIN 1 is black GND).
5. Connect Terminal block to the Motors cable.
6. Use SMA coaxial cable to connect GPS antenna.
7. If LAN Ethernet is going to be used—use regular T5 cable to the LAN hub.
8. Connect regular straight DB9 serial cable to the PC for test terminal connection. Serial port setting are 9600,N.,1,8.
9. Apply power to the DC plug (6-8VDC).
10. Upon power up the welcome screen and after 2-3 sec. Date/Time screen should be displayed on 16×2 LCD.
11. Use KEY5 to toggle between Date/Time, GPS, Inclinometer, RSSI, LIMIT SW. readings.
12. If Terminal is started on PC connected to COM1, then Initial welcome line should appear:

PEN-IO-01 Ready?
13. Type? character to list menu of commands.

********************************************
* Serial Commands List *
********************************************
S - Stop all motors
U - Go Up
D - Go Down
L - Go Left
R - Go Right
E - Read EEPROM Test
W - Write EEPROM Test
T - Display Date / Time
A - List Analog Inputs
I - Limit switches + Dig.Inputs
C - Display Encoder counters
G - Display GPS position
N - Display Ethernet Chip Registers

14. Use UP/DOWN, LEFT/RIGHT keypad keys to control movement of motors
   Notes to schematic diagram in FIG. 5:
1. RSSI input should not exceed 28 VDC
2. Opening of DC motors supply power due to limit switches is being sensed by /FS outputs of U3, U4 DC motor controller. AS motors are moving the voltage on sensing resistor is above 0V (2.5V approx.). If motor stops the current is lowered then voltage drops close to 0V DC which indicates stop condition on the Motors's side.
3. The inclinometer outputs RS232 0-5V format serial packet every 5× second. INP2 is configured as RXD2 receiver and polls this packet every time it is commanded by firmware. Format of packet is 5 bytes:

<STARTCHR=0×E5>,<X Hbyte>,<X Lbyte>,<Y Hbyte>,<Y Hbyte>, <chk sum>
4. The DC motor RP sensors (reed relay, magnetic pickup etc.) are connected to the ENC1,ENC2 inputs and every positive edge on these signal will increment 32 bit
   GPS module can be tested directly with iQ Monitor program (download from manufacturer). To use this option power down controller and during next power up hold down K3 until “GPS Lassen iQ Monitor” message appears on LCD display.
   Connect serial cable to the COM1 of controller and PC. Start iQ Monitor program.
      IQ Monitor will communicate directly to iQ GPS module.

Typically, a self-aligning dish system finds a satellite by sweeping the sky looking for a power level, and once it reads a voltage it reads the signal outputted by the satellite. For example, with the Anik F2 Ku-band an identifier signal is sent, identifying the satellite by name. Once the controller for the Ku-band system receives the identifier, it peaks the voltage and is locked onto the satellite.

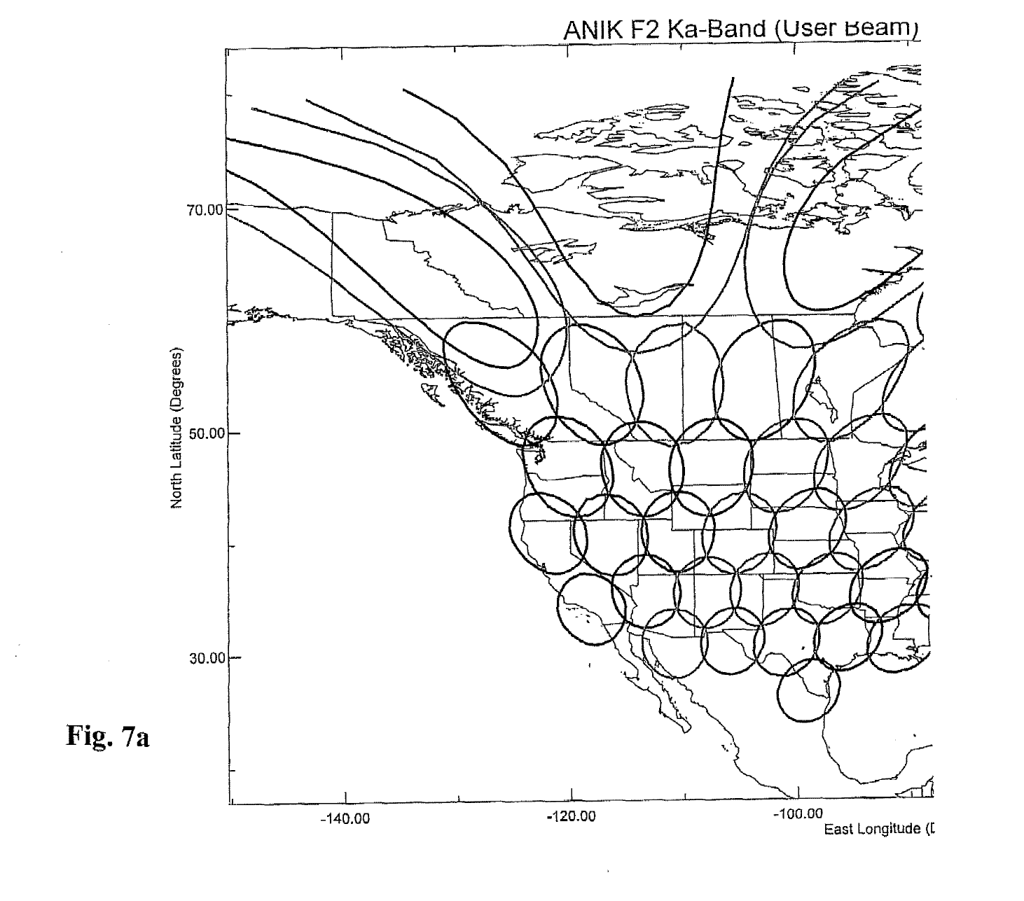

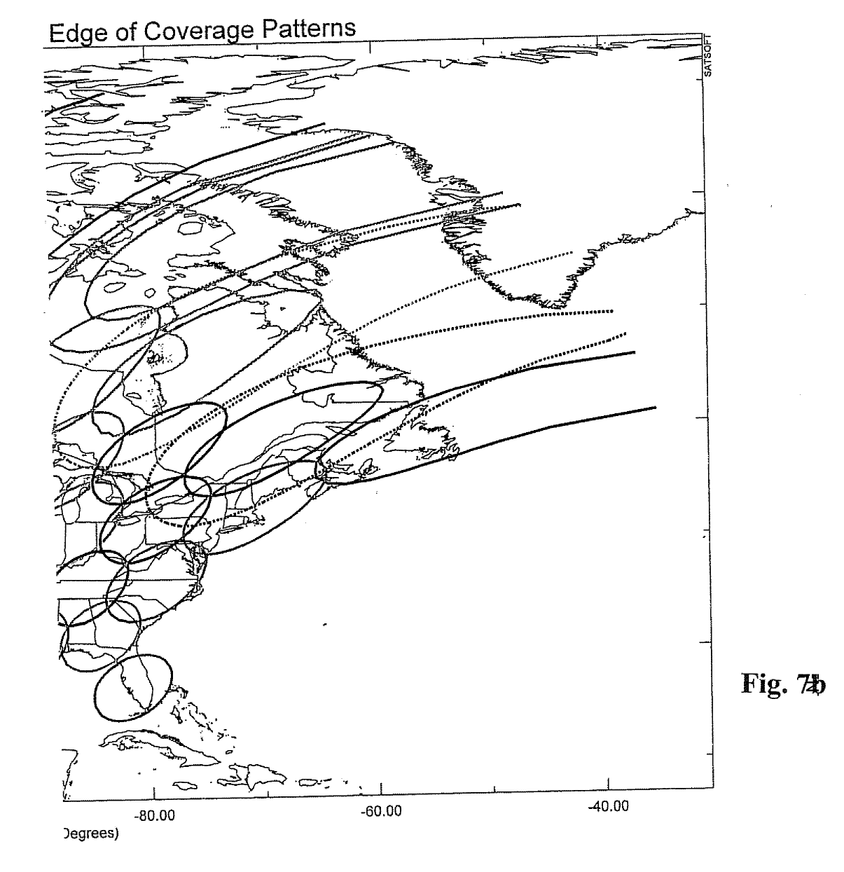

As the present invention is directed to Ka-band service as shown in FIG. 7 and the need for mobile communications functionality, a novel method is proposed herein. The exemplary method for locating the appropriate satellite is as follows:

a. The user sets the on/off switch to the “ON” position;
b. The user then selects the search button located on the front of the controller box;
c. the controller (which is a solid state processor enabled by software, which collects information, calculates the angles/degrees and rotation/position of the dish, and send commands to the motors to move the unit into the desired positions) is then receiving a nema stream of GPS data from a GPS receiver located on the circuit board with an external antenna;
d. the controller is then receiving a stream of inclination data from the outside inclinometer location on the main section of the dish for the X, Y and Z axis;
e. the controller has embedded software that takes the GPS coordinates and determines the elevation of the unit on the earth's surface;
f. the controller then determines the elevation (angle from the earth's surface to the satellite) (this is also referred to as the “look angle”);
g. the controller then calculates the angle of the dish and inputs that into the elevation calculation (a GPS coordinate is used to determine the elevation to which the motors need to raise the dish; for example, the elevation may be 30 degrees from horizon, so the controller would then use an electronic inclinometer to raise the dish until it matched the calculated elevation shot); the position of the satellite is fixed in the sky, therefore one can determine the angle from 90 degrees, based on the elevation of the unit from sea level; the GPS provides the location using X, Y and Z coordinates, from which the elevation can be derived, and the inclinometer provides the horizon, and the angle required to locate the satellite can accordingly be calculated;
h. the unit then sweeps the sky a full 380 degrees looking for the frequency at that calculated elevation;
i. if the dish is unsuccessful at finding the satellite on a sweep at the calculated elevation, then with the use of the electronic inclinometer again the elevation is adjusted either up or down by a number of degrees depending on the count of sweep cycles that the sweep routine has completed; in one preferred embodiment, if sweeping is unsuccessful at the theoretically correct elevation, the elevation is dropped by 2 degrees and another sweep ensues, and, if necessary, a further sweep is conducted with the elevation raised 4 degrees (2 degree increments enable an 8 degree band of sweep across the sky); and
j. when the auto aimer has found the appropriate satellite it then goes through a fine tune sequence (the fine tune sequence starts when the satellite has been located and it is desired to have the highest possible SNR value—the higher the SNR the better the signal strength and the higher the speed of the Internet; the preferred sequence consists of a box whereby the satellite moves in ¼ degree increments, rather that 1 degree increments in the sweep pattern; the box is approximately 5 degrees elevation and 5 degrees azimuth; the controller records the SNR value at each spot in the box, and once the fine tune sequence is complete the dish goes to the point where the SNR value was the highest; this is the most accurate way to gain the highest signal strength from the satellite).

Instead of looking for an identifier code in the satellite signal, the present method involves scanning the sky for a certain frequency range and looking at the signal to noise ratio (SNR). The F2 satellite ranges from 7 to 15 volts. Once the correct SNR is found, it is peaked to find the optimal SNR, then it is confirmed that the correct satellite has been located.

From where the dish finished its sweep cycle and found a signal, it moves up through the signal, all the time keeping track of the highest signal strength. It will then do this for down, left, and then right, as well. It will do this sequence twice to make sure that it has achieved the highest possible signal.

A further exemplary satellite dish system includes a satellite mount, a modem, a controller and a satellite hub. The satellite dish system supplies communications to remote areas.

The mount has a aluminium frame for a sturdy construction. The azimuth turns on a Teflon skid plate for smooth movements at all ambient temperatures. Micro switches for Azimuth and Elevation physical limits to avoid any motor or structural damage. 380 deg of Azimuth movement and 0-90 deg of elevation movements with speed stowing at 1 degrees per second and speed deploying at 5 degrees per second. Fine tune peaking and retuning moves at 0.5 degree increments to insure accurate fine tuning. The incline is measured by an electronic inclinometer with a resolution of 0.1 degree.

Operational temperature had been tested at minus 55 degrees Celsius to plus 40 Celsius. The mount uses a Raven Reflector dish, the antenna dimensions (w×h) 71 cm×65 cm, the operating frequency of the KA system is Tx 29.5-30.0 Ghz Rx 19.7-20.2 Ghz. The dish has also been tested for wind speed as well, it is operational at 80 km/h and can be operational to survival at 130 km/h, and it can survive at 200 km/h

The Surfbeam modem is comparable in size and function to a desktop ADSL of cable modem, just 2.3 by 2.3 by 3.8 cm. SurfBeam Applications include Internet access, Voice-over-IP, MPEG video over IP, High bandwidth FTP and, IP Multicast, however, NetBios and http ports are blocked to incoming traffic at the earth station side.

Dynamic multi-rate forward link provides high availability without throughput loss, rate adaptable MF-TDMA return link, built-in data security, it also encompasses a QoS that will ensure quality of data. 10/100 Mbps Ethernet connections, remote management and control as long as the modem has a receive lock.

Advanced modulation and turbo codes are combined with powerful, dynamic fade mitigation techniques to give the bandwidth the ability to carry more bits.

Current remote side speed tests at high traffic time have been measured at 512 kbps to 2000 kbps download and 64 kbps to 500 kbps upload depending on the service levels subscribed to.

Compared with the current DVB standard, these features result in a capacity 100% to 150% higher per transponder at Ku-band.

The system was built for making upgrades to the remote controller very easy, with software updates being available online very soon. The interface for the controller is either serial or Ethernet, the dimensions for the controller unit are: 8″ by 9″ by 2″. The touch screen is 1″ by 4″.

The system has been built with plenty of failsafe measures, if the inclinometer, fails one can still tune the system using the full sweep menu on the controller. The same goes for the GPS, if the GPS fails to report a proper geo-location, the controller will prompt the operator to manually enter their coordinates.

The controller when powered up goes through a checklist to make sure all hardware is connected and in proper working order.
Inclinometer—Makes sure the inclinometer on the dish has power.
Flash check sum—Checks flash memory.
Signal I/O—Checks onboard RF detector.
GPS I/O—GPS communication check
TCP/IP stack init.—Modem communications.
Modem I/O—Checks to see if the Modem is connected.
Battery backed ram read—Check the on board battery.
Virtual Driver Init. Software check.

The admin section of the controller lets the user to make changes to the system from passwords to fine adjustments to dial in the satellite even faster.

Some of the admin functions that can be altered are:
Change Satellite—You can enter a new satellite latitude. This info is now stored in flash memory. To change satellite again you have to repeat the above steps. The following screen will ask you for the dominant satellite. In certain parts of the world, you may encounter a satellite carrier that is dominant over the carrier you are looking for. We peak the dominant carrier and calculate where your carrier is and move to that location. Enter Latitude of dominant satellite and press (RET).
Signal Threshold—changes the sensitivity of when the controller thinks it might have a signal to peak on, 5.5 in the default, the lower the number the more sensitive it gets.
LAN Info—This function will get the LAN info from your modem and display it on the screen. From IP, subnet masks etc.
Dish Offset—If the dish was not calibrated accurately the dish may not find the satellite first pass because the starting elevation is wrong. If this happens you can recalibrate dish or you can add or subtract degrees to the starting elevation.
Calibrate Dish—If you have changed a motor or controller, you have to calibrate so the dish will be accurate with the controller. The controller keeps counts of where the motor revolutions are.
Modem Password—If you change the admin password in the modem, you have to change the password on the controller to match. The controller initiates a telnet session with the modem and to gain access to the session the admin passwords must match.
Sat Wait Delay—Wait time for verifying satellite. When the controller fine tunes a signal, it will then communicate with the modem to see if the modem has an SNR level.
Peak Type—REG peak uses analog for peaking INT uses modem for peaking, the INT setting will take much longer for acquiring a fine tune of the signal
Inclinometer Type—Allows you to reconfigure controller to accept a different inclinometer if the Inclinometer is replaced.
Cal Touchscreen—Allows you to recalibrate the touch screen if the screen is not sensitive enough, or too sensitive, you can also adjust the contrast of the display.

The satellite hub, the SurfBeam hub includes five components, connected by its own LAN infrastructure.

SMTS-1200 based on a state-of-the-art Cable Modem Termination System (CMTS). This carrier-class edge device manages and controls traffic between satellite network subscribers and the satellite gateway and can route more than 42 million packets per second while managing 16,000 simultaneous traffic flows per satellite interface.

Integrated Performance Enhancing Protocol (PEP) to provide high performance for TCP/IP over broadband, geosynchronous satellite channels. PEP client software is integrated in each subscriber terminal, so no additional software is required on the end user's computer.

Element Management System leverages the well defined Management Information Bases (MIBs) from DOCSIS™ 1.1. The NMS queries and configures devices automatically and remotely, it also keeps the Network Operations Center informed on the status of the network and any errors that might occur. Routing/Switching Infrastructure for access to both the backbone Internet and to the Network Operations Center

Gateway redundancy of all mission critical service elements is designed into the basic gateway architecture.

The network includes internal DNS servers as well as Satellite Modem Configuration server, Web Based Diagnostics & Troubleshooting Server, and a SNMP Manager server.

Numerous modifications, variations and adaptations may be made to the particular embodiments described above without departing from the scope patent disclosure, which is defined in the claims.

1. A satellite dish system for comprising:
a satellite dish mount providing an operable position and a stored position;
a controller for effecting position changes for the satellite dish mount; and
a modem connected to the controller for coupling a computer to a data network via a communications satellite.

2. The system of claim 1, wherein the operable position provides 380 degrees of rotation.

3. The system of claim 1, wherein the operable position provides 90 degrees of elevation.

4. The system of claim 1, wherein the satellite dish mount is operable between minus 55 degrees Celsius and plus 40 degrees Celsius.

5. The system of claim 1, wherein the communications satellite operates in the KA band.

6. The system of claim 1 wherein the controller includes a module for automatically locating a predetermined satellite in dependence upon geographical location.

7. The system of claim 6 wherein the geographical location is provided by a global positioning system (GPS) receiver.

8. The system of claim 6 wherein the geographical location is provided by manual input.

9. The system of claim 6 wherein the module for automatically locating a predetermined satellite includes a module for entering satellite latitude.

10. The system of claim 6 wherein the module for automatically locating a predetermined satellite includes a module for entering signal threshold.

11. A method of aligning a satellite dish comprising the steps of:
a) determining satellite elevation in dependence upon geographic position;
b) rotating the satellite dish at the determined elevation to locate a desired satellite;
c) detecting a signal from the desired satellite; and
d) incrementally adjusting rotation and elevation of the satellite dish in dependence upon signal strength.

12. The method of claim 11, wherein the geographical location is provided by a global positioning system (GPS) receiver.

13. The method of claim 11, wherein the geographical location is provided by manual input.

14. The method of claim 6, further comprising the steps of, when a signal from the desired satellite is not detected determining another elevation and repeating steps b through d.

15. The method of claim 14 wherein the step of determining another elevation includes the step of receiving inclination data.

16. The method of claim 14 wherein the step of determining another elevation includes the step of incrementing the elevation by a predetermined amount.

17. The method of claim 14 wherein the predetermined amount is one of one degree, two degrees, four degrees, minus one degree, minus two degrees, minus four degrees.

18. The method of claim 11, wherein the step of incrementally adjusting rotation and elevation includes the step of adjusting rotation or elevation by within a predetermined range.

19. The method of claim 18 wherein the range is five degrees.

20. The method of claim 18 wherein the increment is less than one degree.
